(19) United States
(12) Patent Application Publication
(10) Pub. No.: US 2019/0158270 A1
(43) Pub. Date: May 23, 2019

(54) Exchanging Asset, Maintenance, And Spares Parts Information Via Blockchain

(71) Applicant: International Business Machines Corporation, Armonk, NY (US)

(72) Inventor: Joseph G. Berti, Denver, CO (US)

(73) Assignee: International Business Machines Corporation, Armonk, NY (US)

(21) Appl. No.: 16/190,822

(22) Filed: Nov. 14, 2018

Related U.S. Application Data
(60) Provisional application No. 62/589,222, filed on Nov. 21, 2017.

(51) Int. Cl. H04L 9/06; H04L 9/30; G06F 21/30; G06Q 10/00

(52) U.S. Cl. CPC H04L 9/0618; H04L 9/30; H04L 2209/38; G06Q 10/20; G06F 21/30

(57) ABSTRACT

A system for generating, tracking, and recording a digital representation of an asset including an electronic log of the attributes, specifications, bill of material, information to replicate parts on a 3D printer or other part duplication device, the assets warranty and claims, recommended maintenance, actual maintenance and parts (a digital footprint or digital twin) for an asset from initial creation, to its sale, during its usage and through decommissioning. The system uses block chain and encryption technology to register information about an asset that is manufactured and for which the digital footprint is to be tracked and recorded. Through use of encryption key pairs and blockchain encryption technology, an electronic document is created in an encrypted transaction log updated at each change to the equipment including the parts and its maintenance records. From the manufacturer or distributor, the asset is shipped with an encryption key that provides access to the equipment information and allows further updates on parts that are added or removed, maintenance performed, warranty work completed and operating metrics are to be provided as available.

### FIELD OF THE INVENTION

The present invention relates to the field of asset management, asset maintenance, spare parts management, and more specifically, to systems, methods, and processes for tracking and recording digital representation of assets.

### BACKGROUND

Recent innovations in computerization of asset management and introduction of remote asset monitoring have enabled asset lifetime performance monitoring and asset maintenance monitoring. Some advanced systems contain an on-board computerized system that records information about the asset. This information enables asset monitoring and failure prediction for the asset. Understanding of asset attributes, specifications, bill of material, asset parts and particularly, accurate asset maintenance record is beneficial to predict asset failures with high accuracy. In addition, knowledge of parts added to the asset, parts removed from the asset, parts replaced in the asset, parts operated in the asset along with when they were added, removed, replaced or operated is useful.

Conventionally, secondary customers, technicians, and other downstream asset users may be unaware of the specifications, age, make, model or other asset attributes as this information is not communicated to the customer electronically or may not persist with the asset. Over time, changes are made to configuration of the asset, possibly by dealers or service technicians. Moreover, maintenance may be performed on the asset that affects the overall condition and operating status of the asset. Lack of knowledge of such maintenance history, parts replacement, parts addition, parts operation and configuration changes may lead to unplanned outages and unnecessary repair costs. The maintenance and configuration information is seldom communicated back to the manufacturer for reliability purposes. To date, there is no comprehensive solution to the above problems that has achieved market acceptance.

Thus, improvements are sought in methods for monitoring performance of the asset, life-cycle of the asset, and predictive maintenance for the asset across a broad range of industries. A digital record may be maintained to monitor various aspects of the asset. The digital record may be built upon an encryption technology, preferably block-chain technology. The encrypted digital representation of the record makes it highly resistant to hacking or improper alteration—especially as the number of transaction logs, or nodes, increases. The encrypted digital record may further enhance security of the asset.

Bock-chain technology is also used for creation, maintenance and administration of crypto-currencies such as Bit-coin. However, use of block-chain technology in Bit-coin, and in other block-chain-based crypto-currencies, creates virtual currencies that have no physical form and are not controlled or valued by a central authority. However, the currently described system and method is specifically used to describe and record information about physical assets. The block-chain encryption technology used to maintain digital record of the physical assets further assures integrity of the record by using an encryption key pair which is accessible by registered authorities.

### SUMMARY OF THE INVENTION

The present invention overcomes disadvantages of the prior art and fulfills the needs described above by providing systems and methods for ensuring integrity of the digital representation of an asset. A data file is created that keeps record of the asset and maintains information regarding creation and use of the asset, asset parts, asset maintenance by using an encryption technology. The data file also records and maintains relevant transaction information regarding the asset.

An electronic log of attributes, specifications, warranty, recommended maintenance, actual maintenance, spare parts usage, predicted failure, actual failure for the asset is created from initial creation, to its sale, during its usage and through to asset decommissioning. Aspects of the present invention include use of block chain and encryption technology to register information about an asset in a digital record having a digital footprint. The digital footprint of the record may be tracked and recorded by using encryption key pairs. Through use of the encryption key pairs and the block-chain encryption technology, an electronic document is created in an encrypted transaction log. The electronic document may be updated at each change to the asset that may include asset parts, asset configuration, asset attributes and asset maintenance records. The asset is shipped from an entity with an encryption key that provides access to the asset information and allows further updates to the information. The updated information may be regarding asset parts that are added or removed, electronic information to recreate components on a 3D printer, maintenance that has occurred on the asset, asset images, asset history, asset failures, warranty work completed, operating conditions, operating status, change of custody, reselling owner information, etc. In some cases, the encryption key pair is transferred with the asset.

Some advantages offered by the solution may include:
1. Manufacturer or owner of the asset is aware of specifications, age, year of making, model, color or any other attribute associated with the asset as it leaves a warehouse and is sold to a dealer or a customer. Electronic record of the asset may be communicated to consumers of the asset. The electronic record may persist with the asset.
2. The electronic information of the asset may be used to replicate parts for the asset by using a 3D printer or other part replicating technology may persist with the asset.
3. Over time, changes may be made to configuration of the asset, possibly by dealers or third-party sellers prior to selling the asset to a customer. The configuration changes may be recorded electronically and stored as part of the digital representation of the asset.
4. Over time, maintenance is performed on the asset that affects overall condition and operating status of the asset. The maintenance may include adding or removing parts from the asset, replacing parts of the asset, operating or repairing parts of the asset. Such maintenance may change the digital representation of the asset and thus may be recorded electronically and stored as part of the digital representation of the asset.
5. Over time, some parts of the asset may fail, and a record of such failures is useful to the manufacturer, dealers and other users of the asset, e.g., to predict fleet failures. Electronic record of part failures may be stored as part of the digital representation of the asset.

The present inventive system leverages aspects of encryption technology (such as block-chain technology which also underlies crypto-currencies such as Bit-coin) to create and maintain an accurate history of specifications of the asset, maintenance performed on the asset, parts used on the asset, configuration changes of the asset, etc. More particularly, the electronic log may use encryption to associate specific attributes and maintenance records with the asset to ensure that overall digital representation of the asset remains accurate and updated. It further allows for custodians (which may include manufacturers, operators, creators, re-sellers or their downstream partners) to record maintenance transactions of the asset at each point in the asset life-cycle. The inventive system will use techniques to append configuration, maintenance and part transactions to the electronic log of the asset. Thus a distributed assurance in the integrity of the transaction log is maintained by updating the electronic record of the asset, each time the asset is modified, maintained and parts are consumed, with each such appended transaction being included in the encrypted transaction log.

One aspect of the invention features, in some embodiments, a system for ensuring integrity of an asset during its life-cycle. The system includes a data file created using an encryption technology; wherein the data file is accessed through an encryption key pair. The data file records and maintains asset specification, asset maintenance information, other asset information and asset part specifications for replicating the asset on 3D printers.

Another aspect of the invention features, in some embodiments, a computerized system for ensuring integrity of an asset digital representation. The system includes: at least one computer server and a plurality of terminals. Each of said plurality of terminals is associated with at least one of a plurality of agents. The at least one computer server operates a software application for performing a method. The method includes registering each of said plurality of agents within the software application. The method includes providing a unique encrypted identifier to each of said registered plurality of agents. The method includes registering an asset by an initial agent, wherein said registration including descriptive specifications of said asset. The method includes encrypting an identity of the asset and the initial agent into a non-repudiatable log. The method includes generating an encryption key for the asset to record further updates to the asset. The method includes registering a maintenance event occurred on said asset by at least one of said plurality of agents working on the asset. The method includes adding a record of the said maintenance event to the non-repudiatable log.

Another aspect of the invention features, in some embodiments, a method for ensuring integrity of an asset digital representation. The method uses encryption technology to record and maintain asset specification, parts, bill of material, recommended maintenance, warranty and actual maintenance performed. The method includes registering at least one custodian for performing maintenance and configuration changes to the asset within a software application. The method includes providing a public/private key pair to said registered custodian. The method includes registering the asset by an initial custodian, said registration including descriptive information of said asset. The custodian uses the public/private key for replacing parts, performing maintenance or making configuration changes on said asset. The method includes generating a report recording maintenance information of the asset.

One embodiment of the invention includes a system for ensuring integrity of digital representation of the asset by creating and using the asset, parts, and maintenance data file. The data file may be built upon encryption technology to record and maintain asset specifications, parts, bill of material, change history, operating conditions, and maintenance transaction information. The data file is built upon encryption technology to record and maintain asset, part, and maintenance transaction information, wherein the encryption technology is block-chain technology.

A further embodiment of the invention is a system for ensuring integrity of an asset digital representation, with the system creating and using the asset, part, and maintenance data file, and the data file being built upon encryption technology to record and maintain asset, part, and maintenance information. The system creates a non-repudiatable log of each maintenance and part usage or failure event from asset generation, manufacture, or registration to and through asset ownership transfer, sale, use or disposal.

Another embodiment of the invention is a computerized system for ensuring integrity of an asset digital representation, said system creating and using an electronic asset, part, and maintenance data file using encryption technology to record and maintain asset, part and maintenance information, said system comprising (a) at least one computer server; (b) a plurality of terminals, each of said plurality of terminals being associated with at least one of a plurality of agents (c) a software application operating on said at least one computer server; wherein said at least one computer server operates a method comprising the steps of: (i) registering each of said plurality of agents within said software application; (ii) providing a unique encrypted identifier to each said registered plurality of agents; (iii) registering an asset by an initial agent, said registration including specifications, bill of materials, specification, make, model, and configuration of said asset; (iv) encrypting an identity of said asset and said initial agent into a non-repudiatable log, including information to replicate a part using 3D printing technology; (v) registering all maintenance events that occur on said asset by each entity performing work on the asset and (vi) adding a record of such events to the said non-repudiatable log. In some embodiments, the initial agent is one of the said plurality of agents.

Still another embodiment of the present invention is a method for ensuring integrity of an asset digital representation, said method creating and using an electronic asset, part, and maintenance data file using encryption technology to record and maintain asset, part, and maintenance information, said method comprising the steps of (a) registering a custodian for performing maintenance and making configuration changes to the asset within said software application; (b) providing a public/private key pair to each said registered custodian; (c) registering an asset by an initial custodian. The initial custodian may be manufacturer, owner, re-seller, third-party agent, technician. The registration of the asset by the custodian may require the custodian to fill asset specifications, bill of materials, asset attributes and asset configuration information within the software application; (d) at each maintenance event of said asset, said each custodian performing maintenance or making configuration changes on said asset. The maintenance event may include modifying the specifications, bill of materials, and configuration information of said asset; (e) at each maintenance event of said asset, generating at least one report. The report may include information regarding new custodian maintaining the asset. The report may further record who is performing the asset maintenance including relevant administrative information. Moreover, the report may be transmitted to other custodians for recording a new entity maintaining said asset. The report may also comprise history of the custodians of the asset, asset details, warranty history, failure history, maintenance history, part usage history, etc. In some applications, registering the asset comprises at least one custodian to fill description of the asset to initiate a block chain custody log.

### BRIEF DESCRIPTION OF THE DRAWINGS

For the purposes of illustrating the invention, the attached drawings show certain aspects and embodiments. However, it should be understood that the invention is not limited to the precise method or process steps or system elements as shown in the accompanying drawings, but rather is further disclosed and claimed according to the attached claims.

FIG. 1 and 1A is a system overview illustration showing multiple events causing creation or updating of the electronic representation of the asset documented in a process flow.

FIGS. 1 and 1B is an overview illustration showing multiple possible stages for creation and updating of the electronic representation of the asset.

FIG. 2 is an exemplary illustration showing asset tracking through the digital representation of the asset utilizing block-chain technology.

FIG. 3 is an exemplary illustration showing the data file representing digital representation of the asset over its life-cycle.

FIG. 4 is an exemplary illustration showing types of reports generated using the information gathered by the system over life-cycle of the asset.

FIG. 5 is an overview illustration showing a network of asset management systems.

FIG. 6 is a flowchart illustrating process flow of asset management system.

### DETAILED DESCRIPTION

Certain terms are used interchangeably herein to describe certain embodiments of the inventive systems, processes, and methods. The use of these terms as referencing particular embodiments or figures should not be construed as limiting the scope of the inventive methods or system. By way of example, the term “entity” may include a distributor, manufacturer, dealer agent, company, third-party maintainer, scrapper, and/or asset custodian. Similarly, the terms digital representation, electronic representation, electronic digital representation, electronic log or simply representation are used to refer to a datafile or non-repudiatable log of the asset. Similarly, the term “asset” is intended to cover any relevant product, material, component, equipment or machinery. Further, the term “blockchain” is used herein to refer to any technology that allows for the creation of a non-repudiatable transaction log that is resistant to unauthorized alteration and is resilient to failures of any one or more elements in the block-chain system.

A core or primary element of the disclosed invention is use of an encryption technology, including in particular, a software encryption technology. The technology may be useful in creating a non-repudiatable, and verifiable electronic log of the asset, part and maintenance of the asset. The electronic log is confirmed/affirmed through use of secure identifiers for each users of the system (e.g., each asset maintainers maintains update, modify, or change the asset information when required).

A leading encryption technology is block-chain encryption technology. By way of overview background, a block-chain is an electronic public ledger of transactions. The block-chain or ledger grows as completed blocks are added to the block-chain. The completed blocks correspond to new transactions or events performed on the asset maintenance performed). The blocks are added to the block-chain in a linear, chronological order, and only registered agents may add or update transactions to the block-chain.

Upon registration of the asset, an initiator of the block-chain receives a public/private key pair to access a computer client software application. The initiator of the asset may be one of plurality of agents. Although the initiator is provided access to the computer client software application, it is important to note that the client software application need not be resident or operating on the initiator's computer. For example, the initiator may be provided access credentials to the application and the application may be accessed over the internee or other suitable communication network. Each key is uniquely associated to and specifically identifies each asset, and is shared with a plurality of agents authorized to make updates to the record of the asset.

The plurality of agents connect to the block-chain network through the client application (e.g., a software application). The client application validates the agent connections and relays transactions (e.g., maintenance performed) from each agent to the block-chain. The block-chain has complete information about each agent address as well as the registered information about all agents from the first genesis block to the most current completed block. Depending upon rules or policies of the block-chain, the encrypted information may or may not be accessed and read by one or more of the plurality of agents. When parties authorized to handle the assets in the digital representation are registered and all assets are registered, the block-chain provides a complete transaction history of each asset and may provide an account of every asset registered in the encrypted transaction log.

Technology underlying the block-chain enables creation of a non-repudiatable, trusted record, even if certain individual parties may not be fully trustworthy. For example, with respect to the encrypted transaction log, in some embodiments, copies of the encrypted transaction log may be distributed among multiple nodes in the block-chain network. Thus, integrity of the transaction log may not be compromised by attacking any single copy of the log. If one copy of the log is improperly altered, it will not match the other copies of the log held by other network nodes. This makes the block-chain highly resistant to hacking or improper alteration—especially as the number of transaction logs, or nodes, increases.

An additional element of the present invention, applicable to some embodiments, is tracking of total log entries of the asset to identify if any updates or changes have occurred on the asset. Another element of the present invention, applicable to some assets or their parts, is serialization of an asset such that each unit or collection of units of the asset is tagged with a unique serial number. Such serialization allows for tracking of an individual asset throughout the performance and maintenance life cycle, in addition to the encryption key.

As described herein, the electronic asset, part, and maintenance log provides a means for recording each change made to the asset, part, and maintenance of the asset, change history, including recording of specifications and identity (e.g., serial number(s)) of each asset in the system.

As part of the initial registration (e.g., by a product manufacturer), and initiation of a block-chain custody log, a description of the product or asset is provided or registered. This initial custody record includes a description of the asset, and any applicable identifying information, including production year, model, configuration, bill of material, diagrams, images, specifications and parts associated with the equipment.

While multiple parties may register assets and initiate a block-chain log, it is important to note that initial registration of the asset creates a beginning point of the asset. More specifically, subsequent updates to the assets are made from the beginning point at which the asset is first registered. In other words, the block-chain asset, part and maintenance log only provides information downstream of the initial asset registration. Information prior to the initiation of the asset, if any, may not be recorded within the block-chain log. While a downstream custodian, for example a distributor may create or initiate a block-chain for the assets it receives if not initiated by the manufacturer, that distributor block-chain may only provide asset, part and maintenance information for those entities downstream of the manufacturer, seller or dealer.

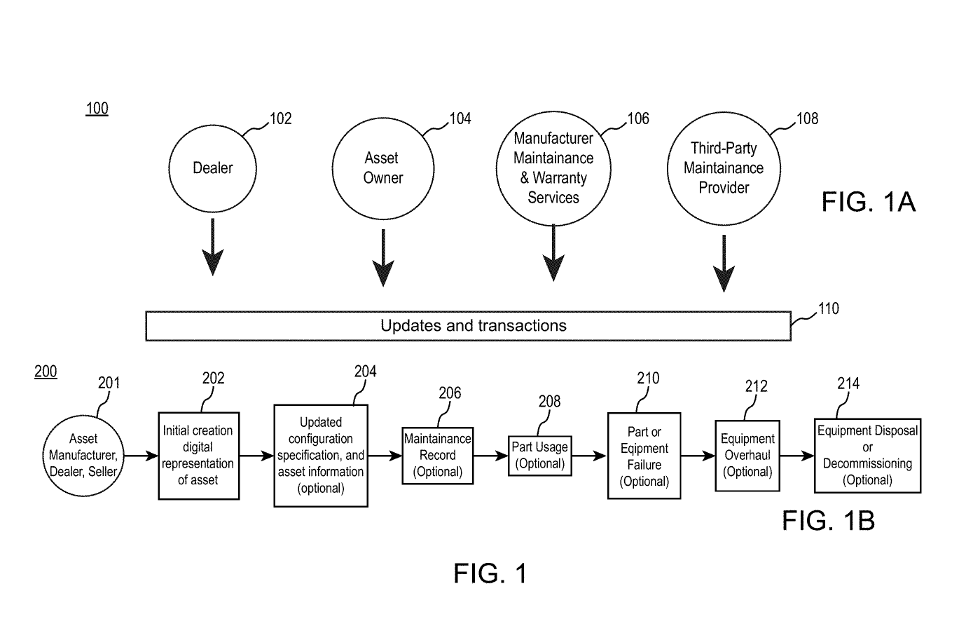

FIG. 1 is a system overview in accordance with one embodiment, representing creation of an electronic representation of the asset. FIG. 1(A) shows a plurality of system elements 100 involved in the creation (or updating) process of the digital representation (i.e. Data File) of the asset. FIG. 1(B) shows a plurality of events that occur during the creation (and/or updating) of the electronic representation of the asset.

With reference to FIG. 1(A), the electronic representation of the asset is generated and updated throughout the life-cycle of the asset. Over the life-cycle of the asset, a plurality of parties may be involved in the creation (and/or updating) of the electronic representation of the asset. The parties may include asset dealer 102, asset owner 104, asset manufacturer (not shown), asset manufacturer maintenance service or asset manufacturer warranty service 106, third-party maintenance provider 108 or any other party may be involved in the asset maintenance. The parties may register the asset into a software application provided on a computer server by entering descriptive information and then update the electronic representation of the asset on an event occurrence. The event may be a maintenance event, custody change event, or any other information regarding the asset. Embodiments of the present invention are not limited to but may include any registered party involved in maintenance of the asset. The updates to the asset or asset transactions may be stored in a block-chain repository 110 in the form of a non-repudiatable log. The repository 110 may be accessed by the registered parties in order to read or update the asset information.

FIG. 1(B) shows a plurality of events 200, that occur during creation (and/or updating) of the electronic representation of the asset. A party 201 may register itself in order to receive authorization to initialize a digital representation of an asset, modify the asset specifications, attributes, maintenance information, etc. The party 201 may be but not limited to asset manufacturer, asset distributor, asset dealer, asset owner, asset manufacturer maintenance service, third-party maintenance provider and the like.

At block 202, the asset is registered by a registered party 201 (initial party) in order to initiate a digital representation of the asset. The initial registration of the asset is typically generated by the asset manufacturer and is published along with placement of the asset into a stream of commerce.

At block 204, the digital representation of the asset is optionally updated by the party 201 on the basis of updates to the asset. The updates may be, but are not limited to, changes to asset configuration, asset specification, and other asset information.

At block 206, a maintenance record is maintained for the asset. The maintenance record may be optionally updated by the registered party 201 when a maintenance event occurs. The maintenance event may include but is not limited to: addition of parts to the asset, removal of parts from the asset, replacement of parts on the asset, operating parts of the asset, repairing of asset parts, etc. The maintenance event may also include lubing of asset parts, cleaning of asset parts, rerfurbishing of asset parts, parts used for maintenance, labor hours consumed, type of maintenance performed, who performed the maintenance, date of maintenance performed, etc.

At block 208, the electronic representation of the asset is optionally updated to reflect part usage information. The asset part usage information may include age of the asset, how much an asset is used, usage rate of the asset, usage history, how frequently the part is used, etc. Over time, parts may fail on the asset and record of failure is useful to the manufacturer, dealers and other users of the asset, e.g., to plan fleet maintenance.

At block 210 of the FIG. 1(B), the electronic representation of the asset is optionally updated to reflect the asset part or equipment failure. The part failure data may also include predicted failure rate of the asset and actual failure rate of the asset. The electronic representation is optionally updated based on updates to asset condition. The part failure data may be updated from asset generation, manufacture, or registration to and through asset ownership transfer, sale, use or disposal.

At block 212 and 214, the electronic representation of the asset s optionally updated based on updates to asset end of life, e.g., equipment overhaul, disposal or decommissioning.

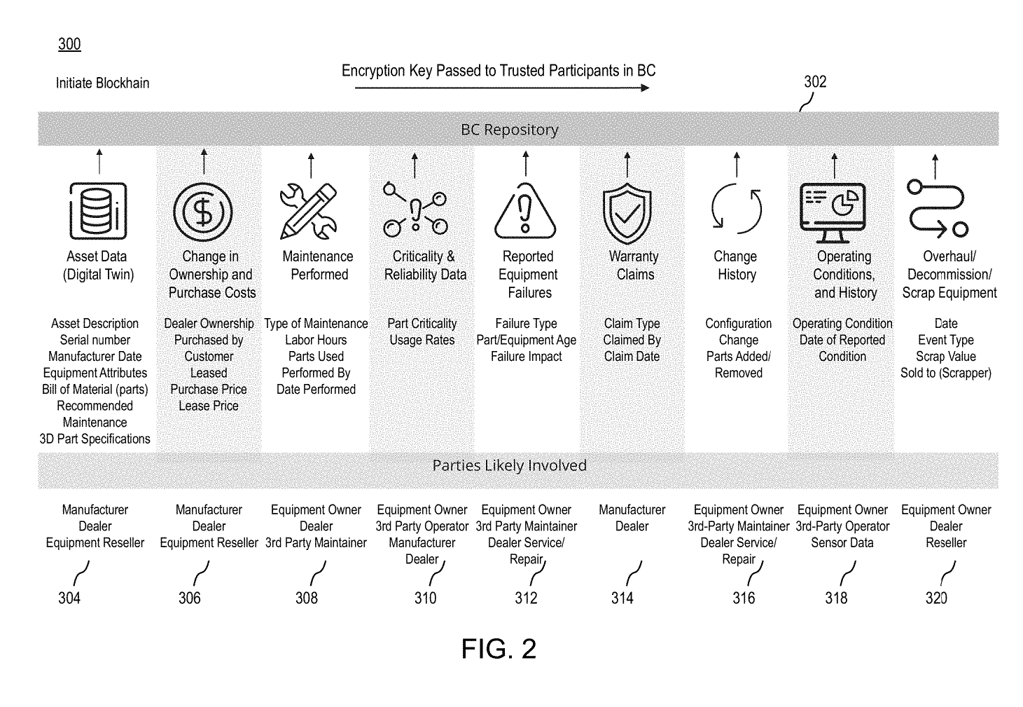

FIG. 2 illustrates an example 300 of an asset electronic record and digital information tracking on the asset via block-chain. The asset is tracked in order to ensure integrity of the asset. The asset in accordance with the present invention may be but is not limited to a physical piece of equipment, e.g., an earth mover or a diesel generator. A data file is created using an encryption technology. The encryption technology may be a block-chain technology. The data file may be in the form of a block-chain repository 302. The block-chain repository 302 records and maintains asset specification, asset maintenance information, other asset information and asset par(specifications for replicating the asset or asset components on 3D printers.

At block 304, the block-chain repository 302 is initiated for the asset. The initiation may be performed by a manufacturer, dealer, equipment re-seller, or any other person having access to the asset and the block-chain repository 302. The asset initiation requires the asset description to be filled in order to represent the asset digitally.

Original asset digital representation data may include but is not limited to, equipment description, serial number, manufacturer date, equipment attributes, bill of material (parts), recommended maintenance, 3D part specifications, and the like. The digital representation or digital twin record is generated by the asset manufacturer and is populated with relevant asset information, e.g., year, make and model of the asset, as well as relevant specifications, and optionally asset drawings or specifications to replicate parts on a 3D printer.

The block-chain repository 302 may be accessible to only trusted participants in the block-chain. The trusted participants may have access to the asset and asset information in the block-chain repository 302. After initialization, identity of the asset may be encrypted by using an encryption key pair. Participants may register themselves with the block-chain repository in order to access the asset. The participants may register by filling in their credentials in order to authorize themselves for the asset access. A registered participant may register a new participant to the system (or the block-chain repository). The participants may access the asset by using valid credentials. The encryption key may be passed along the block-chain to the trusted participants as the asset data changes. The asset data may change upon a change in asset ownership, asset cost, asset specifications, asset attributes, asset warranty, asset operating status, asset operating conditions, etc. The digital representation of the asset is propagated through the block-chain network as the asset is released to a distributor, dealer, equipment re-seller, or otherwise placed in commerce or use.

The digital representation may be updated to reflect changes in asset ownership, e.g., dealer ownership, purchase by customer, lease, purchase price, and lease price. The digital representation may be updated to reflect asset maintenance performed, e.g., type of maintenance, labor hours, parts used, performed by, and date performed. The digital representation may be updated to reflect asset criticality and reliability data, e.g., part criticality and usage rates, with input from equipment owners, third-party operators, manufacturers, dealers, etc. The digital representation may be updated to reflect asset failure data, e.g., failure type, part/equipment age, failure impact, etc. The digital representation may further be updated to reflect warranty claim data, e.g., claim type, claimed by, claim date, etc. The digital representation may also be updated to reflect change history data, e.g., configuration changes, parts added/removed, etc., by the asset owner, third-party maintainer, dealer service/repair, etc. The digital representation may be updated to reflect operating condition and history data of the asset, e.g., operating condition, date of reported condition, etc. Operating condition data or any other relevant data may be captured and reported automatically by wired sensors or via sensors over wireless protocols. The digital representation of the asset may also be updated to reflect overhaul, decommissioning data or equipment scrap data, e.g., scrap date, scrap value, sold to scrapper, etc.

The digital representation of the asset is updated through the asset life-cycle, e.g., with fields for scheduled maintenance, completed maintenance, replacement or refurbishment of parts, number of cycles or duration of use. The block-chain repository 302 may be updated on change in ownership and purchase costs of the asset at block 306. The ownership of the asset may be purchased by another dealer or another customer. The ownership may be further transferred to a re-seller, serviceman, dealer, third-party maintainer, third-party repairer, supplier, distributor, lessor, technician, broker or customer. Price of the asset may also be updated in the block-chain repository 302. The price update of the asset may be a change in purchase price, lease price, re-selling price, after repair price, etc. The price update of the asset may be made by (new or old) owner of the asset who has access to the asset in the block-chain repository 302.

In addition, the block-chain repository 302 may store maintenance data of the asset at block 308. The maintenance data may comprise maintenance performed on the asset through life-cycle of the asset. The maintenance data may be updated by asset owner, asset re-seller, serviceman, dealer, third-party maintainer, third-party repairer, supplier, distributor, lessor, technician, broker, or customer. The maintenance data may comprise adding parts to the asset, removing parts from the asset, replacing asset parts, operating asset parts, maintenance history or any configuration changes for the asset. The maintenance data may further include but is not limited to type of maintenance performed, labor hours spent on the asset maintenance, parts used for the maintenance, who performed the maintenance, date of maintenance performed on the asset. The maintenance data is updated in the block-chain repository 302 by the trusted participant. The repository 302 may also include manufacturers recommended maintenance and actual maintenance performed on the asset.

Further, the block-chain repository 302 comprises criticality and reliability data of the asset at block 310. The criticality and reliability data of the asset may include usage rate of the asset. The asset criticality may depend upon parts used in the asset. The parts of the asset may have a higher quality by being manufactured by renowned brands. The parts may have a lower quality in order to reduce cost of the asset. Thus, the criticality of the asset further affects reliability of the asset.

The asset reliability also comprises usage rate of the asset which may help in predicting the life of the asset.

The block-chain repository 302 maintains asset failure data at block 312. The failure data may comprise type of failure of the asset or impact of the failure on the asset. The failure data may also comprise failure prediction data. The failure prediction data may help owner of the asset to predict a lifetime of the asset or predicting a required maintenance. The asset failure prediction may be based upon asset history, type of parts used in the asset, past maintenance performed on the asset, type of maintenance performed on the asset, parts replaced, operated, repaired in the asset, etc. The asset failure data may also be predicted from the age of asset and age of parts used in the asset. The asset failure data may further depend upon the type of parts used in the asset, i.e., asset criticality and reliability data. The asset failure data may also comprise a record of past failures of the asset. The failure data may be updated by the trusted participant having access to the asset.

At block 314, warranty claims of the asset are updated in the block-chain repository 302. The warranty claims of the asset may be updated by manufacturer of the asset or a dealer of the asset. The warranty claims may comprise claim type, claimed by or claim date of the asset. The claim type may include parts of the asset falling under the asset warranty, amount of damage that may be claimed, type of damage that may be claimed, etc. The warranty claims may also include nominees of the claim in order to specify who may ask for the claim. The warranty data further includes duration of the warranty or date till which the nominee may claim the warranty.

At block 316, history of the asset may be updated in the block-chain repository 302. The history change may reflect configuration change of the asset, parts change, parts added, removed, replaced or operated in the asset. The asset configuration may include various factors which may be software parameters that may affect working of physical parts of the asset. The configuration change may include, e.g., revolutions per minute RPM value, total hours of operation, crude oil consumption, power consumption, pressure or coolant amount, etc. Change in parts of the asset may also be maintained in the block-chain repository 302. The parts change may be addition of parts to the asset, removal of parts from the asset, part maintenance, etc. The parts change may also reflect changing part specifications such as operating temperature, operating conditions, operating status, etc.

With reference to FIG. 2, operating conditions and history of the asset may be updated at block 318. The operating conditions may be updated on the basis of sensor data. The operating conditions may include but are not limited to operating temperature, heat, frequency and power. History of the asset may include report of previous operating conditions of the asset. The history may also include the dates of the reported conditions of the asset. The operating conditions of the asset or various parts of the asset may change with usage, age, operating environment of the asset. The asset operating conditions and history may be maintained by the asset owner, manufacturer, third-party maintainer, dealer, serviceman or repair person.

At block 320, the asset information regarding overhaul, decommission, scrap may be updated in the block chain repository 302. The overhaul data may include, but is not limited to, date, event type, scrap value or information of scrap receiving party. The information may be updated by the asset owner, dealer or asset re-seller.

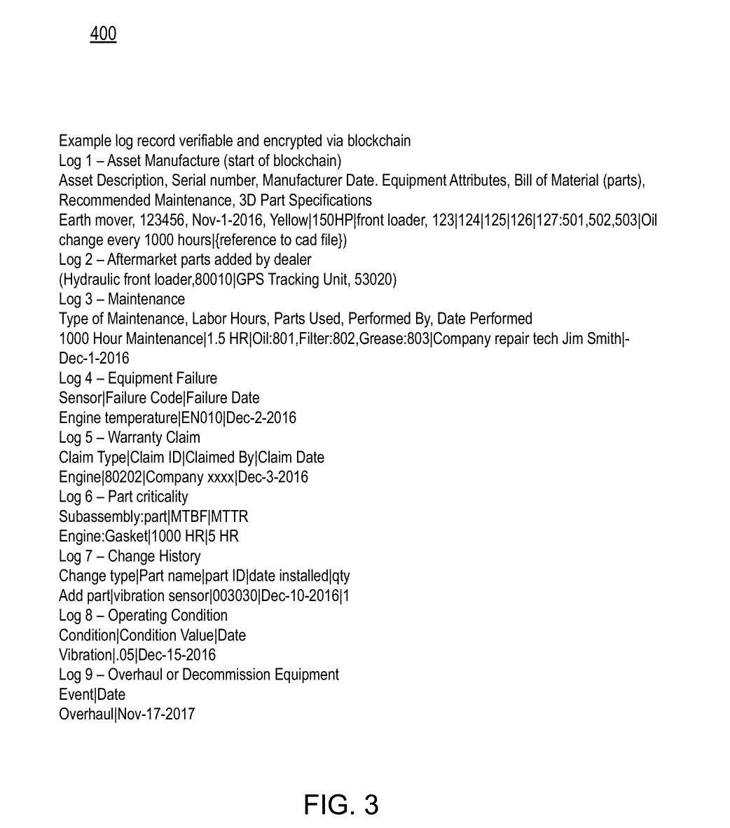

FIG. 3 is an example of a report 400 generated from information gathered by a system over life-cycle of the asset. The report 400 is maintained and updated in order to ensure integrity of asset digital representation. The system may comprise a plurality of terminals in a computer server where each of the plurality of terminals may be associated with one or more plurality of agents. The computer server operates a software application for performing a method to track and record information of the asset by using an encryption technology. The encryption technology may be a block-chain technology. A plurality of agents may be registered within the software application. The registration of the plurality of agents may require the agents to fill in descriptive information into the block-chain about themselves that may specify identity of each agent. Each registered agent is provided with a unique encrypted identifier that may be used to access the asset representation and asset information. An initial agent may register the asset into the block-chain by specifying the identity of the asset. The initial agent may be one of the plurality of registered agents. Identity of the asset and identity of the agent may be encrypted into a non-repudiatable log. The initial agent may be a manufacturer, dealer, supplier, seller, distributor, owner, lessor, serviceman, technician, broker or customer.

Registration of the asset may be performed by filling descriptive specifications of the asset. The asset registration is the start of the block-chain encrypted non-repudiatable log as shown in FIG. 3 by Log 1. The specifications of the asset may include, but are not limited to, year of manufacture, model number, age, color, series, asset diagrams, asset images and parts of identity associated with the asset. The asset specifications may also include asset description, serial number of the asset, manufacture date of the asset, asset attributes, bill of material or parts of the asset, recommended maintenance for the asset, 3D part specifications, etc.

One exam of the asset is an earth mover which has the specifications as 123456, Nov. 1, 2016, Yellow|150HP|front loader, 123|124|125|126|127; 501,502,503|oil change every 1000 hours. The asset specification may be filled by owner of the asset, asset manufacturer, asset dealer, asset third-party service, etc.

Further, updates to the asset information may be performed by the plurality of registered agents by using the encrypted identifier allotted to the agents. At least one of a plurality of agents working on the asset may register a maintenance event occurred on the asset into the non-repudiatable log by using the encrypted identifier. The at least one of a plurality of agents may also add a record of the maintenance event to the non-repudiatable log. The non-repudiatable log records and maintains asset specification, asset maintenance information, bill of material or parts used in the asset, history of bill, history of parts used, asset history, asset warranty, other asset information and asset part specifications for replicating asset parts on 3D printers. Replicating asset parts on 3D printers may be used to form a 3D model of the asset or asset components by using asset specifications.

As shown in FIG. 3, an electronic log/representation 400 for a physical asset, e.g., an engine, transmission, or hydraulic pump, is generated, updated and tracked via block-chain. The digital representation of the asset is initially populated by the manufacturer and updated as the asset moves in commerce transit, warehousing, distribution, purchase) or in the field (e.g., shipping, installation, configuration, calibration, in-use, updates, maintenance, refurbishment, replacement, decommissioning, and the like). Part changes, part failures, sensor readings, maintenance, and the like are tracked and reported in the non-repudiatable log. The non-repudiatable log may include various logs maintained to track the asset information in accordance with various aspects. Log 2 maintains aftermarket parts added to the asset by dealer, re-seller-third-party service, etc. An example of the Log 2 may be Hydraulic Front Loader, 80010|GPS tracking unit, 53020. The Log 2 may also record parts added to the asset, parts removed from the asset, parts operated in the asset, parts replaced in the asset, etc. 1. In some embodiments, the asset is a mining asset, an oil & gas asset, a transportation equipment, public transit equipment, manufacturing asset, or a utility asset digital representation. In some embodiments, the asset is a proprietary, confidential or classified document in a chain of custody. In some embodiments, the system is implemented for determining at least one of the legitimacy of a claim and the authority of a claimant to authorize an action to the asset.

Moreover, a Log 3 as shown in FIG. 3 maintains maintenance events of the asset. The maintenance event may include type of maintenance, labor hours, parts used in maintenance, who performed the maintenance, date on which the maintenance is performed. The type of maintenance may be oiling of components of the asset, greasing of components, brushing, dust removal, change of oil, filter cleaning, etc. The labor hour record may maintain hours spent by the labor during maintenance. Record of the parts used in maintenance may comprise type of parts used, number of times the parts were replaced on the asset, age of parts, etc. The log 3 also maintains record of details of person performing maintenance on the asset. The log 3 keeps record of administrative information of person performing the maintenance. Date of maintenance is also recorded in order to predict certain aspects of the asset such as failure, usage rate, recommended maintenance, actual maintenance, etc. An example of Log 3 record may be:
1000-hour maintenance|1.5 HR|Oil:801,Filter:802,Grease:803|Company repair tech Jim Smith|Dec. 1, 2016.

In addition, a Log 4 is maintained to record asset failure data. The failure data may be predictive failure data or actual failure data for the asset. Failure is predicted from history of the asset maintenance such as parts replaced, type of parts replaced, usage rate of the parts of the asset, brand or company of the parts used in the asset, parts expiration, etc. On the basis of parts used in the asset, a failure of the asset is predicted by owner, dealer, manufacturer, customer, re-seller of the asset. The failure is predicted in order to notify or alert customer or owner of the asset regarding asset maintenance and conditions. The actual failure of the asset is also recorded. The actual failure of the asset may happen at the same time as the prediction, before the prediction or even after the prediction of the failure. The difference between actual failure and the predicted failure may not exceed a certain predetermined time limit. The amount of actual failure happened to the asset or type of the asset failure must also fall under or within certain limits of the predicted failure data. The failure data may be recorded from sensor readings. The type of failure happened to the asset is tracked and recorded along with a certain code specifying the failure type. The system may also keep record of date of the predicted failure and actual failure. Efforts are made in order to minimize the difference between failure prediction and actual failure. An example type of failure record may be:
Sensor|Failure Code|Failure Date
Engine Temperature|EN010|Dec. 2, 2016

Log 5 as shown in the FIG. 3 keeps record of a warranty claim for the asset. Warranty claim of the asset is updated and maintained by either manufacturer of the asset or dealer of the asset. The warranty claim may include claim type, claim ID, claimed by or claim date of the asset. The claim type may include parts of the asset falling under the asset warranty, amount of damage that may be claimed, type of damage that may be claimed, etc. The claim type may comprise the part of the asset that may be claimed such as engine, chassis, cylinders, etc. The claim ID of the asset is related to the claim type. Each part of the asset may have a particular claim ID in order to keep record of claim duration, claim amount, or claim criteria for the part. The warranty claim may also include nominees of the claim in order to specify who may ask for or make a claim. The nominee of the claim may be owner of the asset, customer of the asset, a company or organization associated with the asset. The asset may have different parts added to it and the parts may be manufactured by different companies and organizations. Thus, the warranty claim for each asset part may vary according to the asset type and manufacturing. The customer of the asset may approach the respective manufacturing organization of the asset part in order to access the warranty claim. The warranty data further includes duration of the warranty claim or date till which the nominee may claim the warranty or date of the claimed warranty. An example of the warranty claim may be:
Claim Type|Claim ID|Claimed By|Claim Date
Engine|80202|Company xxxx|Dec. 3, 2016

The non-repudiatable log further maintains and records part criticality in Log 6 as shown in FIG. 3. The criticality and reliability data of the asset may include usage rate of the asset. The asset criticality may depend upon parts or sub-parts used in the asset. The parts of the asset may have a higher quality or a lower quality corresponding to a cost of the asset. Thus, the criticality of the asset may further affect reliability of the asset. The asset reliability also comprises usage rate of the asset which may help in predicting the life of the asset. The asset failure also depends upon type of parts used in the asset, i.e., asset criticality and reliability. The criticality data may be for example:
Subassembly: part|MTBF|MTTR
Engine: Gasket|1000 HR|5HR

History of the asset and its parts is tracked in Log 7 over the lifetime of the asset. The asset history may include type of change performed on the asset. The type of change may include whether various parts are added to the asset, parts are removed from the asset, parts are operated on the asset, parts are replaced in the asset, parts are repaired in the asset, etc. The history may further record a name of the part that is added, removed, operated or replaced in the asset. Part ID of the part added, removed, operated or replaced is also recorded in the log. The date on which the change is made to the asset is also stored to help in keeping record of age of a part, predicting failure of the part, tracking usage rate of the part, etc. In addition, the history log, Log 7 may also record quantity of the change made to the parts of the asset, for example how many parts are added, removed, replaced or operated on the asset. An example history log may be:
Change type|Part name|Part ID|date installed|Qty
Add part|Vibration Sensor|003030|Dec. 10, 2016|1

The non-repudiatable log 400 comprises a Log 8 including a log of operating conditions of the asset. The log 8 records and tracks initial operating conditions, operating status, change in operating conditions with time for the asset. The operating conditions may further be in relation to various parts of the asset. The operating conditions may specify vibration, temperature, operating pressure, frequency, revolutions per minute, crude oil consumption, operating environment, etc.

Each operating parameter may have a particular value stored in the log and the operating value may be updated by manufacturer of the asset, dealer, re-seller, owner, customer, third-party service, repairer, etc. The log 8 also comprises date on which the operating condition is stored. An example of the log 8 may be:
Condition|Condition Value|Date
Vibration|0.05|Dec. 15, 2016

The non-repudiatable log 400 further comprises a Log 9 in order to store and track overhaul or decommission asset data. The log 9 includes asset overhaul and disposal data. The digital representation may be updated to reflect overhaul, decommissioning data or asset scrap data, e.g., scrap date, scrap value, sold to scrapper, etc. The Log 9 may be updated and tracked by asset owner, dealer or re-seller of the asset. An example of Log 9 may be:
Event|Date
Overhaul|Nov. 17, 2017

The non-repudiatable log 400 may be transmitted to the registered agents having access to the asset information. The log 400 may also be transmitted to agents or parties which are not a member of log 400 and do not have access to change or update the asset information. However such parties may have access to read and note the asset information such as in case a party is willing to buy the asset, the party may read the asset information but cannot change or update any data related to the asset. The non-repudiatable log 400 may have administrative information related to agents or parties having access to the log 400. The log 400 comprises record of each asset change from asset manufacture or registration to and through asset final transfer, sale, during its use or upon its disposal.

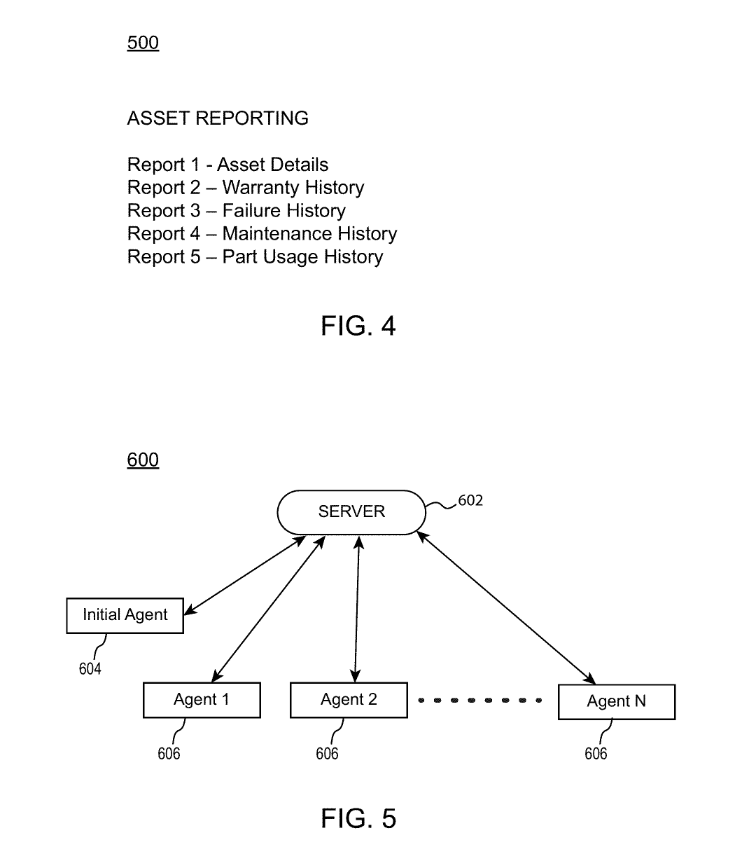

FIG. 4 is an exemplary illustration showing types of reports 500 generated using the information gathered by the system over life-cycle of the asset. The embodiments of the present invention may comprise but are not limited to five types of reports that may be generated by using information of the asset through its lifetime. With reference to FIG. 4, a set of standard reports may be generated by the system. Asset digital representation reports may be generated to document certain details regarding the digital representation of the asset and/or any activity within the digital representation of the asset. Example of Asset digital representation reports may include:
Report 1—Asset Details
Report 2—Warranty History
Report 3—Failure History
Report 4—Maintenance History
Report 5—Part Usage History

Report 1 comprising asset details may include various details of the asset. The asset details in accordance with the present invention may include, but are not limited to, asset description, serial number of the asset, manufacturing date of the asset, asset attributes, bill of material, asset parts, maintenance data, asset part specifications which may be used to represent 3D model of the asset. The asset details may also include operating condition of the asset or operating status of the asset. The asset specifications may further include year of making of the asset, model number, age, color, asset diagrams, asset images, asset parts or identity of the asset.

Report 2 comprises warranty history of the asset. warranty claim may include claim type, claim ID, claimed by, or claim date of the asset. The claim type may include parts of the asset falling under the asset warranty, amount of damage that may be claimed, type of damage that may be claimed, etc. The claim type may comprise the part of the asset that may be claimed such as engine, chassis, cylinders, etc. The claim ID of the asset is related to the claim type. Each part of the asset may have a particular claim ID in order to keep record of claim duration, claim amount, claim criteria for the part. The warranty claim may also include nominees of the claim in order to specify who may ask or claim for the claim. The nominee of the claim may be owner of the asset, customer of the asset, a company or organization associated with the asset. The asset may have different parts added to it and the parts may be manufactured by different companies and organizations. Thus, the warranty claim for each asset part may vary according to the asset type and manufacturing. The customer of the asset may approach the respective manufacturing organization of the asset part in order to access the warranty claim. The warranty data further includes duration of the warranty claim or date till which the nominee may claim the warranty or date of the claimed warranty. An example of the warranty claim may be:
Claim Type|Claim ID|Claimed By|Claim Date
Engine|80202|Company xxxx|Dec. 3, 2016

Report 3 comprises failure history for the asset. The failure history may include failure prediction data and actual failure data for the asset. Failure is predicted from history of the asset maintenance such as parts replaced, type of parts replaced, usage rate of the parts of the asset, brand or company of the parts used in the asset, parts expiration, etc. On the basis of parts used in the asset, failure of the asset is predicted by owner, dealer, manufacturer, customer, re-seller of the asset. The failure is predicted in order to notify or alert the customer or owner of the asset regarding asset maintenance and conditions. The actual failure of the asset is also recorded. The actual failure of the asset may happen at the same time as the prediction, before the prediction or even after the prediction of the failure. The difference between actual failure and the predicted failure must not exceed a certain time limit. The amount of actual failure happened to the asset or type of the asset failure must also fall under or within certain limits of the predicted failure data. The failure data may be recorded from sensor readings. The type of failure happened to the asset is tracked and recorded along with a certain code specifying the failure type. The system may also keep record of date of the predicted failure and actual failure. Efforts are made in order to minimize the difference between failure prediction and actual failure.

Report 4 comprises maintenance history of the asset. The maintenance history of the asset may include various maintenance events of the asset. Maintenance events may include type of maintenance, labor hours, parts used in maintenance, who performed the maintenance, date on which the maintenance is performed. The type of maintenance may include oiling/greasing of components of the asset, cleaning of components, brushing, dust removal, change of oil, filter cleaning, etc. The labor hour record may maintain hours spent by the labor during maintenance. Record of the parts used in maintenance may comprise type of parts used, number of times the parts were replaced on the asset, age of parts, etc. Report 4 also maintains record of details of person performing maintenance on the asset. Record of administrative information of person performing the maintenance is also maintained. Date of maintenance is also recorded in order to predict certain aspects of the asset such as failure, usage rate, recommended maintenance, actual maintenance, etc.

Report 5 comprises part usage history of the asset. Various parts of the asset are tracked, their operating conditions, operating status, sensor readings are recorded in form of digital representation in report 5. Part criticality or reliability data is also maintained. Usage rate of the asset is also stored in the report. The asset usage rate may help in predicting failure rates of the asset. The asset usage rate also helps the manufacturer of the asset to recommend maintenance for the asset. The recommended maintenance and actual maintenance data is stored in the report 4 as discussed in the previous section.

FIG. 5 is an overview illustration showing a network of asset management system. The network 600 comprises a server 602 that may be connected to a plurality of agents 606. The agents 606 may register themselves in order to access the asset information (or digital representation of the asset). The agent registration may include filling in valid credentials by the agents 606 into a block-chain. The registration of the plurality of agents 606 may require the agents to fill in descriptive information into the block-chain about themselves that may specify identity of each agent. Each registered agent is provided a unique encrypted identifier that may be used to access the asset and asset information. An initial agent 604 may register the asset into the asset management network by filling in required descriptive information of the asset. The initial agent 604 may be at least one of the plurality of agents 606 or the initial agent 604 may be a separate entity, not a member of the asset management network. Identity of the asset and identity of the agent may be encrypted into electronically encrypted record. The initial agent 604 may be a manufacturer, dealer, supplier, seller, distributor, owner, lessor, serviceman, technician, broker or customer.

Further, the plurality of agents 606 and the initial agent 604 may be connected to each other via the server 602. The connection between the agents 604, 606 is in such a way that each agent may have access to read the asset information. Any update to the asset information is communicated among each of the agents 604, 606. Each agent may also keep a record of the asset. Update to the asset at one agent may lead to change in record of the asset kept by every other agent. Such a network helps in ensuring integrity of the asset by preventing any fraudulent change to the asset information by non-trustworthy agents. Because of technology underlying the block-chain, a non-repudiatable, trusted record is created, even if certain individual agents may not be fully trustworthy. Copies of the encrypted record are distributed among multiple nodes in the blockchain network, the integrity of the encrypted record cannot be compromised by attacking any single copy of the encrypted record. If one copy of the encrypted record is improperly altered, it will not match the other copies of the encrypted record held by other network nodes. This makes the blockchain network highly resistant to hacking or improper alteration—especially as the number of transaction logs, or nodes, agents increases.

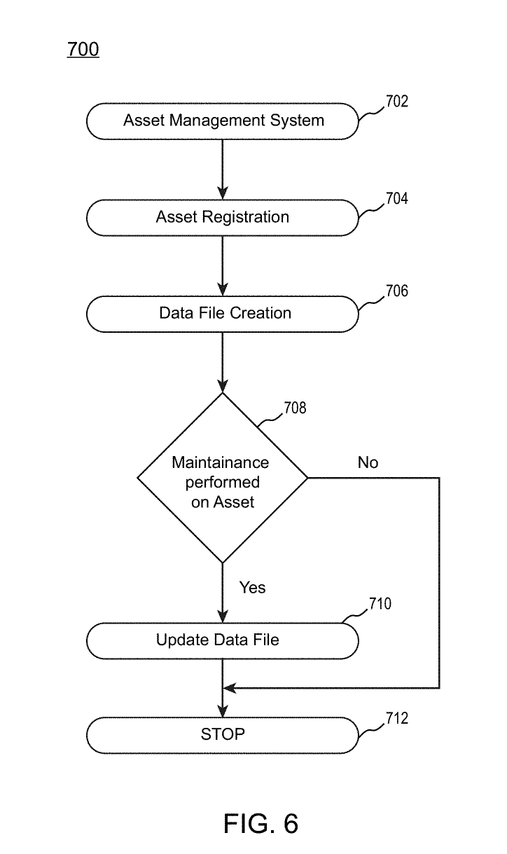

FIG. 6 is flowchart illustrating process flow in asset management 700. The process flow starts at step 702 where an asset management system is initiated to perform a method using encryption technology to record and maintain asset specification, parts, bill of material, recommended maintenance, warranty, actual maintenance performed on the asset, etc. The initial step 702 also requires at least one custodian of the asset to register themselves into the system for performing maintenance and configuration changes to the asset within a software application. The custodian may register themselves by providing descriptive information about themselves in the system that may specify identity of the custodian. The registered custodian is provided a public/private key pair to access the asset. Each registered custodian may have a unique identifier specifying identity of the custodian and the unique identifier is used to access the asset.

An initial custodian may register the asset at step 704. The asset registration may include filling in descriptive information of the asset by the initial custodian. Filling in the descriptive information of the asset leads to initiation of a block-chain custody log. The asset description may include but is not limited to asset specifications, bill of materials, bill of parts of the asset, attributes or configuration information of the asset. The asset registration creates a beginning point of the asset. The initial custodian registering the asset may be one of the registered custodians. In another embodiment of the invention, the initial custodian registering the asset may not be one of the registered custodians. The initial custodian may be a manufacturer of the asset, dealer of the asset, owner of the asset, re-seller of the asset, customer of the asset, etc. The asset specification in accordance with the embodiment of the invention may include, but is not limited to, year of manufacture of the asset, model number of the asset, age of the asset, operating conditions of the asset, etc.

At step 706, with reference to FIG. 6, a data file is created using an encryption technology. The encryption technology may be a block-chain technology. The data file comprises all the information of the asset as well as information related to custodians of the asset. The data file is maintained and updated by the registered custodians using block-chain encryption technology. The data file keeps detailed information of the custodians involved in the asset maintenance that may comprise their name, role, identity, address, etc. The data file also keeps record of the asset information such as asset specifications, asset description, asset maintenance record, record of parts of the asset, asset attributes, asset configuration, asset bill, material, asset history, asset warranty, asset failure record, asset part usage record, etc. The data file may be accessed by only authorized parties to change the asset information. The authorized parties may have an encryption key pair unique to every asset to maintain and update the asset information.

At step 708, it is checked whether maintenance is performed on the asset or not. If maintenance is performed on the asset, the process flow moves to step 710, otherwise, if maintenance is not performed on the asset, the process flow moves to step 712. The maintenance performed on the asset may include change in parts of the asset such as adding parts to the asset, removing parts from the asset, operating parts of the asset, replacing parts of the asset, or repairing asset parts. Maintenance may also comprise changing oil, greasing, lubricating, filter cleaning, tire change, or any other type of maintenance.

At step 710, with reference to FIG. 6, the data file is updated in case a maintenance is performed on the asset. The registered custodians may use the encryption key pair to update and change the asset information. The custodians update the data file to track and record asset changes. The data file may be updated to change part information, change asset specification information, update asset part configuration, bill of parts used in the asset, update material used in asset or its parts, updating reliability and criticality of the asset, maintaining history of the asset, recording data related to labor used to maintain the asset, date of maintenance, etc. Asset history may record each part of the asset with its age, company, reliability, brand, manufacturing organization, usage rate of the part of the asset, etc. The labor data recorded in the data file may comprise name of the person, organization, company or any other entity performing asset maintenance of asset and asset parts. The data file may include administrative information of the person, organization, company or any other entity performing asset maintenance that may include role, authority, etc. of the entity. The data file may also record a new custodian performing maintenance on the asset and asset parts.

Further, the data file may also be transmitted to other custodians for updating their individual records regarding asset information. The data file may also keep a record of history of the custodians of the asset along with their personal and professional details. The data file also records warranty history of the asset, failure history of the asset, maintenance history of the asset and part usage history of the asset.

In case, it is determined that no maintenance is performed on the asset at step 708 the process flow moves to step 712, where the record keeping and data file updating is completed for the asset.

It will be recognized by those skilled in the art that other modifications, substitutions, and/or other applications are possible and such modifications, substitutions, and applications are within the scope and spirit of the present invention. It is likewise understood that the attached claims are intended to cover all such modifications, substitutions, and/or applications.

The foregoing description is merely exemplary embodiments of the present invention, but is not intended to limit the scope of the claims of the present invention. Therefore, equivalent changes made according to the claims of the present invention shall fall within the scope of the present invention.

What is claimed is:

1. A system for ensuring integrity of an asset during its life-cycle, the system comprises:
a data file created using an encryption technology; wherein the data file is accessed through an encryption key pair; wherein
the data file records and maintains asset specification, asset maintenance information, other asset information and asset part specifications for replicating the asset on 3D printers.

2. The system according to claim 1, wherein the encryption technology is block-chain encryption technology and wherein the data file is an encrypted transaction log that is updated at each change to the asset.

3. The system according to claim 1, wherein the data file comprises an electronic record of each asset change from asset manufacture or asset registration to and through the asset final transfer, sale, use or disposal.

4. The system according to claim 1, wherein the system registers an asset to be tracked using a digital representation and records each change to the asset; wherein the change comprises at least one of: adding a part, removing a part, replacing a part and performing maintenance in the encrypted transaction log.

5. The system according to claim 1, wherein the data file records maintenance information for the asset comprising at least one of: a part added to the asset, a part removed from the asset, a part replaced from the asset, a part operated in the asset, maintenance history, configuration changes, type of maintenance, labor hours, parts used, maintenance performed by, and date of maintenance performed.

6. The system according to claim 1, wherein the data file is used to track and record at least one of predicted failure rates for the asset and its parts and actual failure rates for the asset and its parts.

7. The system according to claim 1, wherein the other asset information comprises at least one of: an actual maintenance performed on the asset, electronic asset bill, the asset history, warranty, asset images, operating conditions of the asset or reselling owner information.

8. The system according to claim 1, wherein the asset specification comprises at least one of: a year of making, a model number, age, color, asset diagrams, asset images, parts, identity associated with the asset, operating conditions, operating status or sensor readings.

9. A computerized system for ensuring integrity of an asset digital representation, wherein the system comprises;
a. at least one computer server;
b. a plurality of terminals, wherein each of said plurality of terminals is associated with at least one of a plurality of agents;
wherein said at least one computer server operates a software application for performing a method comprising the steps of:
i. registering each of said plurality of agents within the software application;
ii. providing a unique encrypted identifier to each of said registered plurality of agents;
iii. registering an asset by an initial agent, wherein said registration including descriptive specifications of said asset;
iv. encrypting an identity of the asset and the initial agent into a non-repudiatable log;
v. generating an encryption key for the asset to record further updates to the asset;
vi. registering a maintenance event occurred on said asset by at least one of said plurality of agents working on the asset; and
vii. adding a record of the said maintenance event to the non-repudiatable log.

10. The computerized system according to claim 9, wherein the non-repudiatable log is created using block chain encryption technology and wherein the encryption key is uniquely associated to and specifically identifies each asset, wherein the system provides credentials to allow access to said software application for each authorized entity, person or company that has the encryption key for the asset to make updates to the non-repudiatable log.

11. The computerized system according to claim 9, wherein the initial agent is one of a manufacturer, dealer, supplier, seller, distributor, owner, lessor, serviceman, technician, broker and customer; wherein the non-repudiatable log records and maintains at least one of an asset specification, asset maintenance information, other asset information, bill, history, warranty, and asset part specification for replicating on 3D printers; and wherein the asset specification comprises at least one of an year of making, model number, age, color, asset diagrams, asset images and parts or identity associated with the asset.

12. The computerized system according to claim 9, wherein the system transmits the non-repudiatable log to at least one of a first party being a member of said digital representation and a second party not a member of said digital representation, wherein said non-repudiatable log comprises at least one of relevant administrative information; a record of each equipment change from asset manufacture or registration to and through asset final transfer, sale, during its use or upon its disposal.

13. The computerized system according to claim 9, wherein the system registers assets using a digital representation and records changes made to the asset in the encrypted transaction log; wherein asset registration comprises asset specification, bill of materials, attributes and configuration in,formation of the asset.

14. The computerized system according to claim 9, wherein the maintenance event comprises at least one of: a part added to the asset, a part removed from the asset, a part is replaced, a part is operated, maintenance history, configuration changes, type of maintenance, labor hours, parts used, maintenance performed by and date of maintenance performed.

15. A method for ensuring integrity of an asset digital representation, said method using encryption technology to record and maintain asset specification, parts, bill of material, recommended maintenance, warranty and actual maintenance performed, wherein said method comprises the steps of:
a. registering at least one custodian for performing maintenance and configuration changes to the asset within a software application;
b. providing a public/private key pair to said registered custodian;
c. registering the asset by an initial custodian, said registration including descriptive information of said asset;
d. the custodian uses the public/private key for replacing parts, performing maintenance or making configuration changes on said asset;
e. generating a report recording maintenance information of the asset.

16. The method according to claim 15, wherein the encryption technology is block chain technology.

17. The method according to claim 15, wherein the asset specification comprises at least one of: an year of making, a model number, age, color, asset diagrams, asset images, parts and identity associated with the asset.

18. The method according to claim 15, wherein the maintenance information comprises at least one of: a part added to the asset, part removed from the asset, part replaced, part operated, maintenance history, configuration change, type of maintenance, labor hours, parts used, maintenance performed by and date of maintenance performed.

19. The method according to claim 15, wherein a description of the asset comprises at least one of: asset specifications, bill of materials, attributes and configuration information of the asset, custodian maintaining the asset.

20. The method according to claim 15, wherein the report comprises at least one of: history of the custodians of the asset, asset details, warranty history, failure history, maintenance history and part usage history.
